(19) United States
(12) Patent Application Publication
(10) Pub. No.: US 2005/0091621 A1
(43) Pub. Date: Apr. 28, 2005

(54) Methods for designing a circuit

(76) Inventors: David N. Goldberg, San Jose, CA (US); Edward R. Helder, Freemont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/692,607

(22) Filed: Oct. 24, 2003

(51) Int. Cl. G06F 9/45

(52) U.S. Cl. 716/6

(57) ABSTRACT

In one embodiment, the present invention is directed to a method of designing an application specific integrated circuit (ASIC). The method comprises (a) performing static timing analysis on versions of an ASIC design multiple times before routing the ASIC design utilizing path delays that are estimated according to cardinality of fanout of nets of the ASIC design and (b) performing static timing analysis on versions of the ASIC design multiple times before routing the ASIC design utilizing path delays that are calculated from estimated routing distances within a current version of the ASIC design, wherein step (a) is performed more frequently than step (b).

### TECHNICAL FIELD

The present invention is generally related to circuit design and, more particularly, to methods for performing timing analysis during circuit development.

### BACKGROUND

Application Specific Integrated Circuit (ASIC) design typically begins by describing the desired logic or functionality of the ASIC in a non-technology dependent hardware description language (HDL). An example of a suitable HDL is the Register Transfer Language (RTL). An RTL language is referred to as a non-technology dependent language, because it does not define the functionality of an ASIC in terms of specific gates or elements. Instead, the RTL language describes the functionality of an ASIC by specifying the logical operations performable by an ASIC and the effect of the logical operations on registers of the ASIC. For example, the RTL expression ADD R1←R1+R2 may describe the operation of a logical element that adds the contents of register two to the contents of register one and then stores the result in register one.

After the initial creation of the logical description, the HDL may be provided to a functional simulation to verify the behavior of the design. Upon suitable verification, logical synthesis may occur in which gate level elements are selected to implement the defined logical operations. The gate elements are typically selected from a library of cell elements provided by an ASIC vendor. The cell elements represent physical logical elements associated with a particular fabrication process. The cell elements may identify the particular logical element, its size, the number and location of ports, the delay associated with its respective operations, and/or the like. Additional logical circuits (e.g., scan elements) may be included for diagnostic and test purposes.

Using the gate-level design, initial circuit partitioning may occur. The partitioning is typically referred to as “floor planning.” In this design stage, an initial estimate of the circuit size is made. Moreover, related circuit elements that may be advantageously grouped together are identified to facilitate a subsequent layout process. Logic simulation and static timing analysis may be performed to verify the gate-level design and to extract estimates of timing parameters. Formal verification and test structure verification may be performed to ensure that the desired functional behavior has been retained. Technology specific verification may also be performed to ensure that the design does not violate design constraints that are specific to the technology selected for the cells of the cell library.

The gate-level design and the timing information generated during the static timing analysis may be integrated into a suitable database. The database may facilitate layout of the device according to a physical realization of the device. The typical layout process includes the steps of partitioning (e.g., grouping related circuit elements), placement of circuit elements, and routing (e.g., creation of wiring between the circuit elements). The layout process is performed in an iterative manner. Specifically, the process begins with the initial partitioning specified during the floor-planning stage. The iterations refine the circuit partitions down to the circuit element level. These cells are then placed according to constraints which are determined by a cost function. The constraints may reflect local timing and power considerations. The routing of the wiring interconnections is also performed according to a set of constraints.

A final static timing analysis is performed on the routed layout design. The final static analysis is typically performed on a computationally intensive basis utilizing three-dimensional modeling and lumped RC analysis. If the final static timing analysis identifies a problem in any of the circuit paths, an optimization cycle is initiated by flagging the gates along the problematic signal paths and returning back to the gate-level synthesis. An attempt is made to improve the logical synthesis to eliminate the timing problems. All of the steps subsequent to the logical synthesis are repeated until the final static timing analysis determines that the physical layout is satisfactory.

It shall be appreciated that repeating the various steps is quite disadvantageous due to the additional expenditure of time and other resources. Moreover, if the repetition of the logic synthesis does not solve the identified problems, it may be necessary to modify the RTL description. However, this is the worst case scenario, because it essentially involves starting the design over from the beginning.

In an effort to cause an ASIC design to satisfy the comprehensive final static timing analysis, timing estimates may be periodically performed to determine whether the progressing design is converging to the required timing constraints. If the timing estimates tend to indicate that a design will not satisfy the timing constraints, the design process may return to the logic synthesis stage at an earlier point. It shall be appreciated that the timing estimates are typically performed by utilizing the relatively rudimentary wire load model. The wire load model is used due to the relatively minimal computational resources needed to perform the timing analysis. Accordingly, the analysis does not appreciably interfere with concurrently performed activities. However, wire load models lack accuracy and the results of such an analysis may deviate from actual timing delays by a significant margin. Therefore, timing problems may not be revealed by the timing estimation of the prior art.

### SUMMARY

In one embodiment, the present invention is directed to a method of designing an application specific integrated circuit (ASIC). The method comprises (a) performing static timing analysis on versions of an ASIC design multiple times before routing the ASIC design utilizing path delays that are estimated according to cardinality of fanout of nets of the ASIC design and (b) performing static timing analysis on versions of the ASIC design multiple times before routing the ASIC design utilizing path delays that are calculated from estimated routing distances within a current version of the ASIC design, wherein step (a) is performed more frequently than step (b).

### DESCRIPTION OF THE DRAWINGS

FIG. 1 depicts an ASIC design process according to the prior art.

FIG. 2 depicts a timing analysis process according to embodiments of the present invention.

FIG. 3 depicts a flowchart for performing timing analysis according to embodiments of the present invention.

FIG. 4 depicts a flowchart for an ASIC design process according to one representative embodiment.

### DETAILED DESCRIPTION

In embodiments of the present invention, a static timing analysis software tool may be executed on a frequent basis during the course of development of an ASIC design. Static timing typically refers to timing analysis performed at the highest operating frequency of an ASIC to determine whether the ASIC satisfies required set-up and hold times. The static timing analysis software tool analyzes the paths through a circuit and attempts to estimate signal delay through the paths utilizing a predetermined function or algorithm. If any circuit path violates required set-up or hold times, the circuit path is identified for further adaptation.

The frequently executed timing analysis may advantageously utilize a low complexity, low computationally intensive algorithm to determine the estimated delay of the current state of the ASIC design. By utilizing a low complexity, low computationally intensive algorithm, embodiments of the present invention do not divert appreciable hardware resources to perform the computation of the timing analysis or appreciable human resources to prepare and manage the analysis. Thus, the frequent timing analysis does not impede or otherwise interfere with other ongoing circuit design processes.

On a less frequent basis, a more complex timing analysis may be implemented before routing of the ASIC. The less frequently executed timing analysis may enable the less frequent timing analysis to provide more accurate results and, hence, ensures that the development of the ASIC design is actually proceeding toward a physically realizable circuit. Specifically, the less frequently executed timing analysis may serve multiple purposes. The less frequently executed timing analysis may provide feedback to enable modification of the low complexity, low computationally intensive algorithm. Thus, further iterations of the low complexity, low computationally intensive algorithm will not tend to diverge from actual timing delays to the extent observed by known design processes. Moreover, the less frequently executed timing analysis may identify severe timing issues at an earlier stage. If a sufficiently problematic timing issue is discovered, the ASIC design development may modify the RTL code, reapply logical synthesis, or reiterate any suitable design process at an earlier stage than would otherwise be performed according to known ASIC design techniques. Thus, embodiments of the present invention may avoid fruitless optimization of an unsuitable ASIC design that would not be adaptable to defined performance requirements.

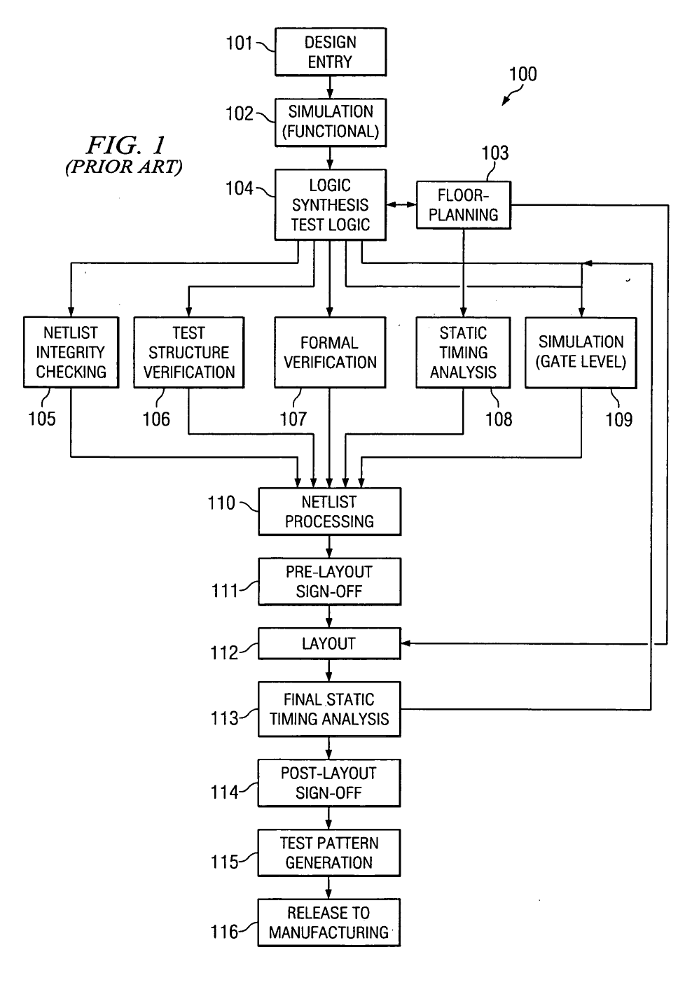

Before discussing the present invention in greater detail, it is appropriate to review known ASIC design processes. FIG. 1 depicts ASIC design process 100 according to the prior art. As shown in FIG. 1, an integrated circuit design is captured by a design entry step 101. Design entry step 101 is typically facilitated by a design capture system allowing the user to specify the logic design of the integrated circuit graphically, through a hardware description language (e.g., VHDL), or both.

Upon completion of design entry step 101, a functional simulator is typically used to verify functional behavior of the design (step 102). Based on a verified functional level description (“functional design”), logical synthesis may occur in step 104. Logical synthesis involves selecting cell components from a cell library and the creation of netlists of the selected cell components according to the functional design. Also, at logic synthesis step 104, circuits for diagnostic and test purposes are included. For example, suitable circuits may include test circuits for a boundary scan design.

Using the gate-level design, floor planning may be performed to create an initial circuit partitioning (step 103). The initial circuit partitioning involves a first estimate of circuit size and groupings of highly connected portions of the design. The gate-level design may be verified (in netlist integrity checking step 105) to ensure that technology-specific logic design rules (e.g., cell/circuit compatibility, connectivity rules, cell selection rules, other compatibility rules, and/or the like) are not violated. The gate-level design may also be verified against both the behavior description of the testing/diagnostic circuit elements and the functional design to ensure both the test structure behavior (step 106) and the functional design behavior (step 107) are preserved. In addition, a static timing analysis (step 108) and a logic simulation (step 109) are performed on the gate-level design to extract timing parameters and to verify the gate-level design's functional behavior.

The gate-level design, Input-Output information, physical constraints, testing provisions, and the timing parameters are integrated into a pre-layout design database in the netlist processing step 110. At this time, a pre-layout signoff step 111 signifies the beginning of the physical realization phase of the integrated circuit design. The physical realization occurs during circuit layout (step 112) in which the physical realization (“layout”) is created by performing a number of tasks (“layout design tasks”) iteratively.

Typically, layout design tasks include circuit partitioning, placement, and routing. As mentioned above, an initial circuit partition based on the gate-level design is already performed at step 103. Based on this initial partition, the circuit partitioning in step 112 further refines circuit partitions down to the level of individual cells (e.g., logic gates or macro cells). These cells are then placed according to some constraints which are typically expressed by a cost function. Typical constraints are related to area, power, and local timing. The placed cells are then routed to provide the necessary interconnect wiring. The routing is typically performed according to local timing and power constraints.

A final static timing analysis step 113 is then performed on the routed layout design, incorporating into the timing information delays introduced by the routing step. The final static analysis is typically performed on a computationally intensive basis utilizing three-dimensional modeling and lumped RC analysis. If final static timing analysis step 113 identifies timing problems in some signal paths, an optimization cycle is initiated by either flagging the gates along the problematic signal paths or by applying various techniques to perform local optimization of logic for the purpose of improving timing. In logic synthesis step 104, logic synthesis techniques are applied to improve the gate-level design in a revised gate-level design. Steps 105-113 are then repeated on the revised gate-level design. This optimization cycle is repeated until all timing problems are resolved, represented by the post-layout sign-off step 114. Clearly, repetition of these steps is quite undesirable. Specifically, repetition of these steps incurs additional expense for the development of the integrated circuit. Moreover, repetition of these steps may significantly delay the commercial release of the integrated circuit which is disadvantageous from a business perspective.

If the static timing analysis performed in step 113 indicates that the timing of the integrated circuit satisfies the defined timing requirements, automatic test pattern generation (ATPG) may be performed to provide test patterns to the circuit in step 115. Then, the final layout design can be manufactured by providing the design to the appropriate integrated circuit mask fabrication entity (step 116).

As previously noted, ASIC design processes may require undesired repetition of various design steps if the static timing analysis performed after routing does not satisfy the defined timing requirement. To address this issue, periodic timing analysis may be performed according to the prior art utilizing wire load models. The purpose of applying wire load models periodically during the design process is to identify timing problems at the earliest possible stage. If a problem is identified early, unnecessary further design steps may be avoided. Specifically, the resynthesis may occur at an earlier stage. Also, the application of periodic timing analysis may reduce the number of resynthesis iterations associated with the development of an integrated circuit.

The advantage of wire load models is their simplicity. Specifically, wire load models require little computational operations. Thus, these models do not divert appreciable processing resources from other design algorithms. In general, a wire load model attempts to relate the timing delay of a circuit to the estimated length of the nets of an ASIC. A net refers to a set of mutually interconnected wiring traces of the ASIC. Wire load models predict wire delay without any physical information describing the coordinates of cell components that are connected by a net. Instead, wire load models typically utilize a lookup table for the delay (among other properties) of a net, solely based on the cardinality of its fanout. The cardinality of a net refers to the number of branches of the net (e.g., a net associated with multiple ports). The values for fanouts that are not listed in the table may be linearly interpolated. Although the table model does simplify calculation of the delay associated with a net, the rudimentary nature of the model is associated with an appreciable degree of inaccuracy. The inaccuracy of the wire load models are problematic, because actual timing delays may diverge from actual delays. Thus, although the application of periodic static timing analysis utilizing wire load models is helpful, it is possible that the periodic timing analysis may not identify a timing problem before the routing stage.

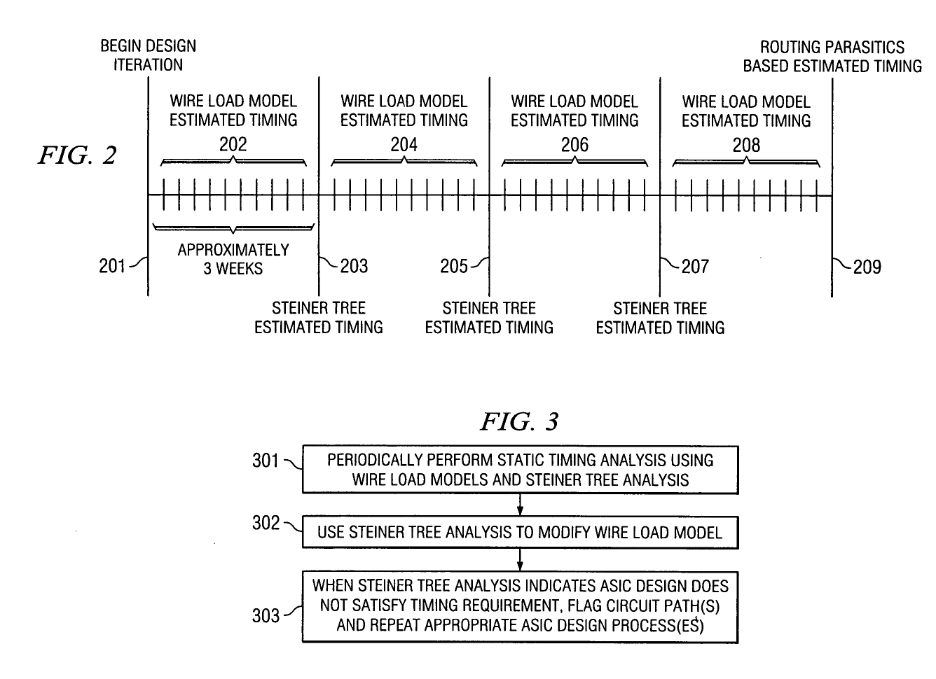

Embodiments of the present invention may identify problematic timing paths at an earlier stage by utilizing a timing algorithm that is more accurate than timing algorithms based on wire load models. Additionally, embodiments of the present invention may employ the more accurate timing algorithm at selected times such that the more accurate timing algorithm does not appreciably interfere with other integrated circuit design processes. FIG. 2 depicts time analysis process 200 according to embodiments of the present invention. At point 201, the design iteration may begin. For example, point 201 may be associated with synthesis of a design into a gate-level design (see step 104 of FIG. 1). Timing analysis process 200 may advantageously provide static timing analysis with increasing accuracy and periodic validation. In embodiments of the present invention, estimated timing analysis utilizing a wire load model may occur on a relatively frequent basis (e.g., every two days) during period 202. In embodiments of the present invention, period 202 may be three weeks for example. Design personnel may utilize the low complexity static timing analysis to guide their activities during this period.

At the end of period 202, embodiments of the present invention may employ a more accurate algorithm to perform a more thorough estimated timing analysis. In embodiments of the present invention, an estimated timing analysis utilizing a suitable Steiner tree algorithm may be employed at point 203. The Steiner tree “problem” is well known in the art for determining wire routing of an ASIC design. In the Steiner tree analysis, a set of points or terminals (referred to as set “S”) are established. For an ASIC design, each point or terminal in the set are the points on the ASIC where a wiring connection couples to a port of a cell component. A Steiner tree is an in-plane tree that contains the set S. The Steiner tree problem is finding the Steiner tree of minimum length. In general, the application of the Steiner tree problem to ASIC design involves limiting the wiring interconnections to so-called “Manhattan routing,” i.e., the routing only occurs in two orthogonal directions. By limiting the routing in this manner, the Steiner tree problem is limited to a special case referred to as the rectilinear Steiner tree problem. A method for determining optimum rectilinear Steiner trees is shown in the article “The Rectilinear Steiner Problem,” by F. K. Hwang, Journal of Design Automation and Fault-Tolerant Computing, Vol. 2, pp. 303-310, 1979. After the optimum rectilinear Steiner tree is determined, the delay associated with a particular path may be determined by multiplying the length of the path (as defined by the Steiner tree) by appropriate resistivity and capacitive parameters associated with the material that will be used to implement the connections.

Although one embodiment uses an algorithm to determine an optimal Steiner tree, other algorithms and/or other models may be employed to generate estimates of routing distances between logical elements. Other suitable algorithms include maze routing, shortest path based algorithms, line-probing algorithms, integer programming (IP) algorithms, and the like. Other suitable routing models include grid graph modeling, checker board graph modeling, and channel intersection modeling, and the like. From the other models and algorithms, estimates of routing distances may be obtained and delays calculated using appropriate resistivity and capacitive parameters.

The process of performing frequent wire load modeling and less frequent Steiner tree analysis may be repeated several times. As shown in FIG. 2, wire load modeling occurs during periods 202, 204, 206, and 208. Steiner tree analysis is performed between the periods at points 203, 205, and 207. It shall be appreciated that embodiments of the present invention are not limited to any particular number of wire load and/or Steiner tree analyses. Embodiments may employ any number of wire load timing estimations of the circuit operation over any appropriate time period. Also, any suitable number of Steiner tree analyses may be performed as long as the selected Steiner tree analyses do not divert an unsuitable amount of resources from other circuit design processes.

After the selected number of analyses are performed and after the circuit design reaches the routing stage (see step 112 of FIG. 1), static timing analysis (see step 113 of FIG. 1) may occur utilizing routing parasitic based on routed layout design. If the final static timing analysis is suitable, the routed layout design may be provided to the fabrication facility for mask generation and ultimately for device fabrication. It shall be appreciated that embodiments of the present invention significantly reduce the probability that problematic circuit paths will be identified by the final static timing analysis. Specifically, analysis utilizing Steiner tree estimates are substantially more accurate than traditional wire load models. Accordingly, problematic circuit paths will be identified at an earlier stage thereby permitting the problematic circuit paths to be addressed at an earlier stage.

FIG. 3 depicts a flowchart for performing timing analysis according to embodiments of the present invention. In step 301, static timing analysis is performed periodically using wire load models and Steiner tree analysis. In step 302, the Steiner tree analysis is used to modify the wire load model. In step 303, when the Steiner tree analysis indicates that the ASIC design does not satisfy a timing requirement, a circuit path or paths may be flagged and appropriate ASIC design process(es) may be repeated.

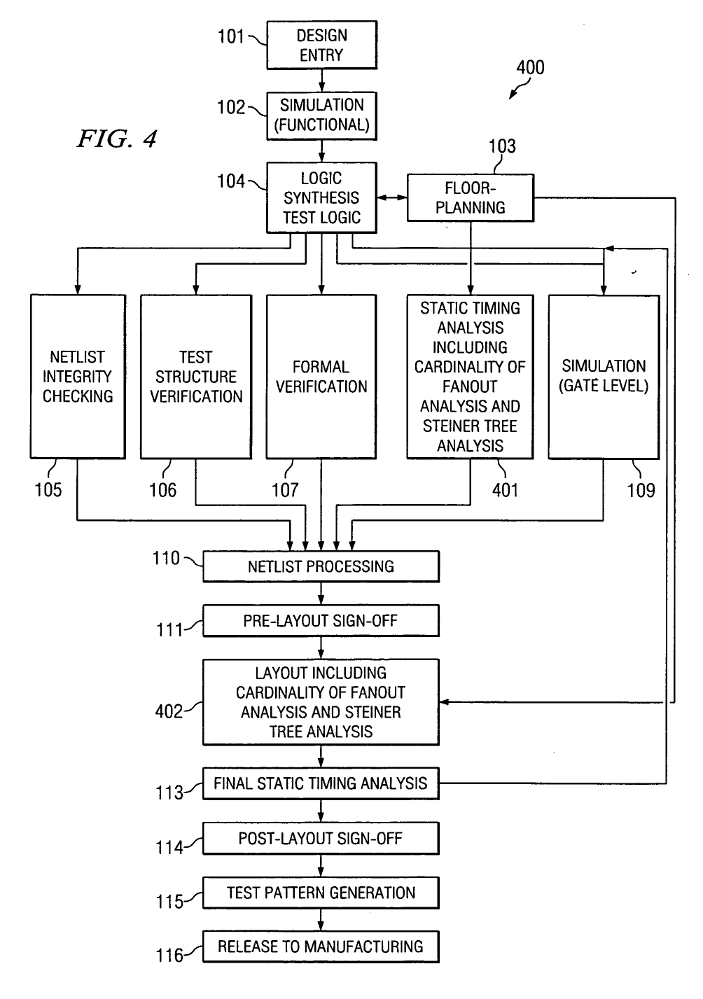

FIG. 4 depicts flowchart 400 for an ASIC design process according to one representative embodiment. As previously noted, Steiner tree analysis is known in the art. According to known circuit design techniques, Steiner tree analysis merely occurs during the routing of the wire connections of an integrated circuit and after optimization of cell component positioning. In contrast, embodiments of the present invention may utilize Steiner tree analysis as a timing analysis to provide feedback to the preliminary design stages. For example, static timing analysis 401 may employ timing analysis using both cardinality of fanout and Steiner tree analysis. Likewise, cardinality of fanout and Steiner tree analysis may occur to direct layout 402 of the circuit design. Additionally, embodiments of the present invention may coordinate the timing and frequency of the Steiner tree analyses in a manner to avoid appreciable interference with other design processes. Thus, the computational and other resources necessary for the Steiner tree analyses do not unduly impede the progress of the circuit development while facilitating convergence of the circuit design to a functional device that conforms to defined requirements.

1. A method of designing an application specific integrated circuit (ASIC), comprising:
(a) performing static timing analysis on versions of an ASIC design multiple times before routing said ASIC design utilizing path delays that are estimated according to cardinality of fanout of nets of said ASIC design; and
(b) performing static timing analysis on versions of said ASIC design multiple times before routing said ASIC design utilizing path delays that are calculated from estimated routing distances within a current version of said ASIC design, wherein step (a) is performed more frequently than step (b).

2. The method of claim 1 further comprising:
determining from a Steiner tree analysis that said ASIC design does not satisfy a timing requirement.

3. The method of claim 1 further comprising:
flagging a circuit path of said ASIC design that does not satisfy a timing requirement.

4. The method of claim 3 further comprising:
repeating at least one ASIC design process to adapt said flagged circuit path to said timing requirement.

5. The method of claim 4 wherein said at least one ASIC design process is logical synthesis.

6. The method of claim 4 wherein said repeating at least one ASIC design process includes modifying a register transfer language description.

7. The method of claim 1 further comprising:
utilizing a static timing analysis estimated from a Steiner tree to modify a wire load model utilized to estimate timing delays associated with said cardinality of fanout of nets.

8. The method of claim 7 further comprising:
updating a wire load table.

9. The method of claim 8 wherein said wire load table comprises estimated capacitive loads of nets associated with a plurality of cardinal values of fanout.

10. The method of claim 1 further comprising:
routing said ASIC design; and
performing a timing analysis after performing said routing utilizing three-dimensional modeling of said ASIC design and lumped RC analysis.

11. A method of designing an application specific integrated circuit (ASIC), comprising:
(a) performing floor planning of an ASIC design;
(b) performing layout of said ASIC design;
(c) routing said ASIC design;
(d) performing static timing analysis on versions of said ASIC design multiple times during steps (a)-(b) utilizing path delays that are estimated according to cardinality of fanout of nets of said ASIC design; and
(e) performing static timing analysis on versions of said ASIC design multiple times during steps (a)-(b) utilizing path delays that are calculated from estimated routing distances within a current version of said ASIC design, wherein step (d) is performed more frequently than step (e).

12. The method of claim 11 further comprising:
determining from a Steiner tree analysis that said ASIC design does not satisfy a timing requirement.

13. The method of claim 11 further comprising:
flagging a circuit path of said ASIC design that does not satisfy a timing requirement.

14. The method of claim 13 further comprising:
repeating at least one ASIC design process to adapt said flagged circuit path to said timing requirement.

15. The method of claim 14 wherein said at least one ASIC design process is logical synthesis.

16. The method of claim 14 further comprising:
modifying a register transfer language description before repeating steps (a) and (b).

17. The method of claim 11 further comprising:
utilizing a static timing analysis estimated from a Steiner tree to modify a wire load model utilized to estimate timing delays associated with said cardinality of fanout of nets.

18. The method of claim 17 further comprising:
updating a wire load table.

19. The method of claim 18 wherein said wire load table comprises estimated capacitive loads of nets associated with a plurality of cardinal values of fanout.

20. The method of claim 11 further comprising:
performing a timing analysis on said routed ASIC design utilizing three-dimensional modeling of said ASIC design and lumped RC analysis.
